(19) United States
(12) Patent Application Publication
(10) Pub. No.: US 2026/0210867 A1
(43) Pub. Date: Jul. 23, 2026

(54) HIGH TEMPERATURE IN SITU OPTICAL ABSORPTION AND PHOTOLUMINESCENCE PROBE

(71) Applicant: THE BOARD OF TRUSTEES OF THE UNIVERSITY OF ILLINOIS, URBANA, IL (US)

(72) Inventors: Moonsub Shim, Savoy, IL (US); Logan Keating, Hillsboro, OR (US)

(73) Assignee: THE BOARD OF TRUSTEES OF THE UNIVERSITY OF ILLINOIS, URBANA, IL (US)

(21) Appl. No.: 19/403,585

(22) Filed: Nov. 28, 2025

Related U.S. Application Data
(60) Provisional application No. 63/726,083, filed on Nov. 27, 2024.

(51) Int. Cl. G01N 21/85; G01N 21/39; G01N 21/64

(52) U.S. Cl. CPC G01N 21/8507; G01N 21/39; G01N 21/64; G01N 2021/399

(57) ABSTRACT

An optical probe system is disclosed for in situ optical spectroscopy and photoluminescence measurements on high-temperature reactions. The system includes an optical probe comprising an optical housing, a main probe body, and an adjustable solution window. The optical housing is thermally isolated and houses a collimating lens for coupling light from a source. The main probe body includes a transparent waveguide and a protective sleeve, while the adjustable solution window incorporates a mirror for reflecting light back to a fiber optic, with an adjustable path length. The system may also include a heatbreak for thermal isolation, a hermetic sealing ring, and a tilt-translate mechanism for lens alignment. The system may also provide a bifurcated optical fiber, spectrometer, color balancing filter, and multiple light sources for switching between spectroscopy across UV, Vis, and IR spectra and PL measurement. The system enables precise, high-temperature optical analysis with adjustable geometry and robust sealing.

### REFERENCE TO EARLIER FILED APPLICATION

This application claims the benefit under 35 U.S.C. § 119(e) of U.S. Provisional Patent Application No. 63/726,083, filed Nov. 27, 2024, which is incorporated herein, in its entirety, by this reference.

### BACKGROUND

Spectroscopic techniques such as UV-Vis absorption and photoluminescence are widely used to monitor chemical reactions, determine concentration changes, and analyze material properties. These methods are particularly valuable in nanocrystal synthesis, where particle size and distribution influence optical and electronic characteristics. Real-time monitoring during synthesis allows precise control over reaction conditions, improving reproducibility and product quality.

Conventional in situ probes for UV-Vis and PL measurements typically employ fiber optics and epoxy-sealed windows. While effective at moderate temperatures, these designs fail under conditions exceeding approximately 300° C. because epoxy degrades and optical fibers cannot withstand prolonged exposure to extreme heat. Commercial probes also lack adjustable path length and vacuum tolerance, limiting their applicability in high-temperature reactions such as quantum dot synthesis or catalytic cracking.

In situ UV-Vis-IR spectroscopy approaches are generally conducted at lower temperatures (<300° C.) and occasionally with custom glassware, but these approaches do not replicate the conditions of high-temperature synthesis. Epoxy-based seals and polymer components impose a hard ceiling on operating temperature. Furthermore, many reactions require vacuum sealing and integration with standard glassware, which existing designs cannot provide. There is a need for a robust, vacuum-tolerant, high-temperature optical probe that isolates sensitive optics from the reaction environment while maintaining precise optical alignment and adjustable path length.

### BRIEF SUMMARY

Embodiments of the present disclosure include optical absorption and photoluminescence (PL) probes. In one embodiment, an optical probe system for in situ optical spectroscopy on high-temperature reactions is capable of measurements spectral regions such as ultraviolet (UV), visible (Vis), and infrared (IR). The system comprises an in situ optical probe having an optical housing, a main probe body, and an adjustable solution window. The optical housing is thermally separated from the reaction and includes a collimating lens for receiving and collimating light from a light source. The main probe body includes a transparent waveguide coupled between the optical housing and the adjustable solution window for transmitting light, and a sleeve that houses and protects the waveguide. The adjustable solution window includes a mirror configured to reflect incoming light back to a fiber optic, wherein the distance between the mirror and the end of the transparent waveguide is adjustable to modify the optical path length.

In an embodiment, the system further comprises a heatbreak that adapts the optical housing to the main probe body and isolates the optical housing from excessive heat, and a sealing ring surrounding the transparent waveguide and compressed by the heatbreak to provide a hermetic seal under vacuum and positive pressure.

In an embodiment, the optical housing includes a tilt and translate mechanism for adjusting alignment of the collimating lens.

In an embodiment, the system further comprises a Xenon lamp as the light source, a color balancing filter accentuating blue light from the spectral signature of the lamp, a bifurcated optical fiber with three legs—one coupled to the light source, one delivering light into the probe, and one returning reflected light—and a spectrometer coupled to the third leg for measuring spectra.

In an embodiment, the transparent waveguide is a quartz rod.

In an embodiment, the main probe body includes a threaded mirror holder for adjusting the distance between the mirror and the waveguide.

In an embodiment, the mirror comprises polished stainless steel, and the sleeve includes a 14/20 taper for interfacing with chemical glassware.

In another embodiment an optical probe system is capable of in situ photoluminescence (PL) measurement of a reaction at elevated temperature, with the system comprising a light source, a bifurcated optical fiber, and an in situ PL probe with an optical housing, main probe body, and adjustable solution window. The optical housing is thermally separated and includes a collimating lens. The main probe body includes a transparent waveguide and a protective sleeve. The adjustable solution window includes a mirror for reflecting light back to the fiber and a spectrometer for measuring PL.

In an embodiment, the light source is a laser diode.

In an embodiment, the system includes a long-pass filter coupled between the probe and the spectrometer to remove excitation wavelengths.

In an embodiment, the system includes a heatbreak and sealing ring for thermal isolation and hermetic sealing.

In an embodiment, the main probe body includes a threaded mirror holder for adjusting path length.

In an embodiment, the mirror comprises polished stainless steel, the sleeve includes a 14/20 taper, and the waveguide is quartz.

In another embodiment, an optical probe system is capable of switching between in situ optical spectroscopy and in situ photoluminescence measurement. The system includes multiple light sources, a bifurcated optical fiber, and an in situ probe with an optical housing, main probe body, and mirror. The probe operates in a first mode for optical spectroscopy across UV, visible, and infrared spectra, and a second mode for PL measurement. A spectrometer is coupled to the third leg of the fiber for measuring spectra or PL depending on the mode.

In an embodiment, the system includes one or more shutters for switching between modes.

In an embodiment, the system includes first and second beam splitters and a plurality of mirrors for redirecting light between shutters and beam splitters.

In an embodiment, the probe includes a collimating lens, heatbreak, sealing ring, and protective sleeve.

In an embodiment, the path length between the waveguide and mirror is adjustable.

In an embodiment, the plurality of light sources includes a Xenon lamp and a laser diode.

These and other features, objects and advantages of the present invention will become better understood from the description that follows. In the description, reference is made to the accompanying drawings, which form a part hereof and in which there is shown by way of illustration, not limitation, embodiments of the invention.

### BRIEF DESCRIPTION OF THE DRAWINGS

The features, objects and advantages other than those set forth above will become more readily apparent when consideration is given to the detailed description below. Such detailed description makes reference to the following drawings, wherein:

FIG. 1A shows an in situ optical probe in accordance with an embodiment of the present disclosure. FIG. 1B is a schematic diagram showing optical design and alignment in accordance with an embodiment of the present disclosure.

FIG. 2 is a schematic diagram showing a photoluminescence configuration in accordance with an embodiment of the present disclosure.

FIG. 3A is a schematic diagram showing an optical probe system configured to operate in a photoluminescence mode. FIG. 3B is a schematic diagram showing the optical probe system of FIG. 3A configured to operate in an optical spectroscopy mode.

FIG. 4 shows temperature profile of the reaction solution (upper graph) compared to the skin temperature at the optical probe at the height of the sealing ring (lower graph).

FIG. 5A shows in situ absorption spectra of CdSe QD reaction mixture obtained using the embodiment of the probe shown in the FIG. 1a. Spectra were collected every 10 ms (integration time of 2 ms). Spectrum averaging (50 scans) and a moving average filter (5 points) were used to reduce noise. The resulting spectra are spaced by ~540 ms, and can be readily analyzed via automated methods. The artifacts at ~490nm are due to peaks in the xenon lamp spectrum. FIG. 5B shows in situ absorption spectra of CdSe QD reaction mixture with rapid acquisition. The spectra in this series are ~10 ms apart, and have a 25-point moving average filter applied. Two spectra at early times are omitted due to large fluctuations in intensity, likely due to residual bubbles from the injection process. Note that t=0.000 s is assigned as the time a spectrum was collected immediately prior to when a significant spectral feature was detected. Spectra are offset for clarity.

FIG. 6 shows a normalized comparison of in situ and ex situ UV-Vis spectra of CdSe QDs at the end of synthesis. The in situ spectrum was taken at 25.8° C. in crude solution containing TOPO, stearic acid and toluene, with an integration time of 2 ms and a path length of ~0.5 mm. The in situ spectrum shown here is the result of averaging 100 spectra and applying a 10-point moving average filter. By contrast, the ex situ spectrum was taken at 20.2° C. and is the result of adding 60 μL of a 50/50 crude/toluene aliquot into 3 mL of toluene, with an integration time of 1 s and a path length of 1 cm. The two spectra show excellent agreement.

FIG. 7 shows: (a) Raw, uncorrected in situ spectrum. (b) Baseline subtraction of the raw spectrum using the mean between 700-750 nm. (c) Application of 25-point moving average filter (lower trace). (d) “Background” estimate of the spectrum (upper trace) and subtraction (lower trade). (e) Initial peak guess and refinement using windowed local maximum. (f) The numerical derivative of the spectrum after the moving average filter. Considerable smoothing is necessary for interpretation. (g) Identification of the FWHM via a simple search for the HWHM value. (h) The residual of the spectrum and the gaussian peak. (i) Plot of the time between spectra as a function of measurement number. The temporal spacing between spectra is non-uniform and there are occasional buffering periods where the acquisition time spikes. In all cases, the acquisition time is considerably larger than the nominal integration time (0.002 s).

FIG. 8 shows: (a) Peak position as a function of time determined via the methodology outlined in FIG. 7(b) Absorbance at the first exciton peak wavelength as a function of time. The initial variation seen in the plot is likely due to some level of instability brought about by the hot injection of precursors into the solution. Although attempts were made to minimize the disturbance of the solution, rapid hot injection is, by definition, a somewhat violent process that will cause solution agitation.

FIG. 9 shows photoluminescence spectra obtained in situ at elevated temperatures.

While the present invention is susceptible to various modifications and alternative forms, exemplary embodiments thereof are shown by way of example in the drawings and are herein described in detail. It should be understood, however, that the description of exemplary embodiments is not intended to limit the invention to the particular forms disclosed, but on the contrary, the intention is to cover all modifications, equivalents and alternatives falling within the spirit and scope of the invention. Reference should therefore be made to the embodiments above and claims below for interpreting the scope of the invention.

### DESCRIPTION

For the purpose of promoting an understanding of the principles of the invention, reference will now be made to certain embodiments thereof and specific language will be used to describe the same. It will nevertheless be understood that no limitation of the scope of the invention is thereby intended, such alterations, further modifications and applications of the principles of the invention as illustrated herein being contemplated as would normally occur to one of skill in the art.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

Embodiments of the present disclosure include optical absorption and photoluminescence (PL) probes. Certain embodiments address the challenges of high-temperature in situ spectroscopy by relocating sensitive optical components away from the reaction zone and employing materials capable of withstanding extreme conditions. In certain embodiments, the probe assembly integrates with standard laboratory glassware, allowing seamless adoption in existing setups. In certain embodiments, the design is vacuum-tolerant and chemically inert, enabling degassing and reaction monitoring under harsh conditions.

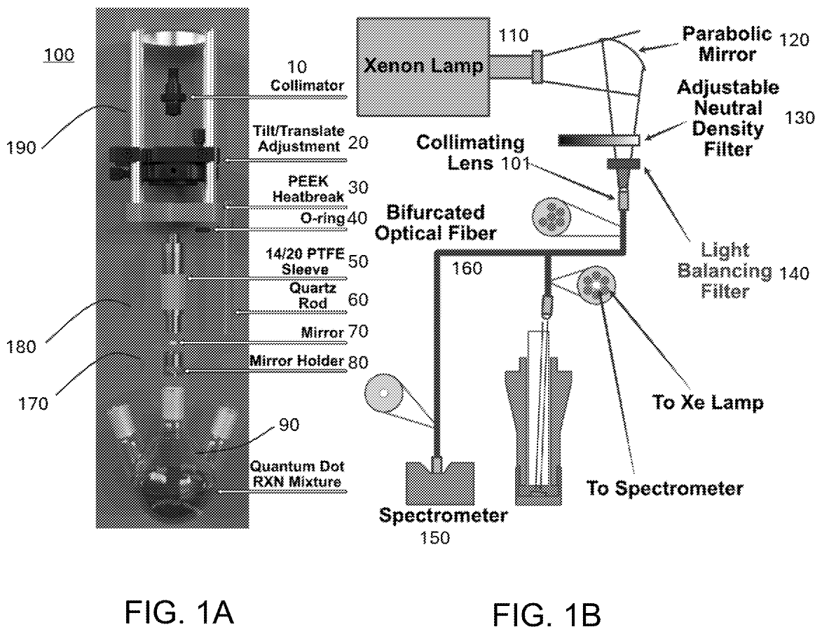

FIG. 1a illustrates an embodiment of an in situ optical probe 100 configured for high-temperature operation, suitable for measurements across ultraviolet (UV), visible (Vis), and infrared (IR) spectral regions. As shown, the probe comprises an optical housing 190, a main probe body 180, and an adjustable solution window 170. The optical housing 190 contains a collimating lens 10 mounted on a tilt/translate platform 20 for precise alignment, and interfaces with a bifurcated optical fiber 160. FIG. 1b schematically depicts the optical coupling between a light source 110 (e.g., a Xenon lamp) and the probe 100 via a collimating lens 101, as well as the return path to a spectrometer 150. The bifurcated fiber 160 includes three legs: a first leg coupled to the light source 110, a second leg delivering light into the probe 100 through the collimating lens 10, and a third leg returning reflected light to the spectrometer 150. The skew alignment of lens 10 and mirror 70, exaggerated in FIG. 1b, minimizes internal reflections from the transparent waveguide 50 (e.g., a quartz rod).

In an embodiment, the main probe body 180 houses the transparent waveguide 60 within a protective sleeve 50. The sleeve may include a threaded upper portion and a 14/20 taper for compatibility with standard glassware. A heatbreak 30, formed from a thermally insulating material (e.g., PEEK), couples the optical housing 190 to the main probe body 180, reducing thermal transfer and compressing a sealing ring 40 (e.g., a Kalrez® o-ring) to maintain vacuum integrity. This arrangement isolates sensitive optics from the reaction zone while enabling operation at temperatures exceeding 300° C.

In an embodiment, the adjustable solution window 170 terminates the probe and includes a mirror 70 positioned opposite the waveguide 60. The mirror 70 reflects incident light back through the waveguide toward the spectrometer, enabling absorbance measurements without introducing additional optical components into the reaction mixture. The mirror holder 80 may be threaded to allow fine adjustment of the distance between the mirror and the waveguide, thereby defining the optical path length. This adjustability supports quantitative UV-Vis-IR measurements across a wide range of solution concentrations.

In an embodiment, sealing to the external environment is achieved through two interfaces: (i) a 14/20 taper cut into the stainless-steel portion of the flask 90, sealed with a PTFE sleeve and vacuum grease, and (ii) compression of the o-ring 40 against the quartz waveguide 60 by the heatbreak 30. This dual-seal configuration provides vacuum tolerance and positive-pressure capability, enabling integration with Schlenk-line setups and other high-temperature reaction systems.

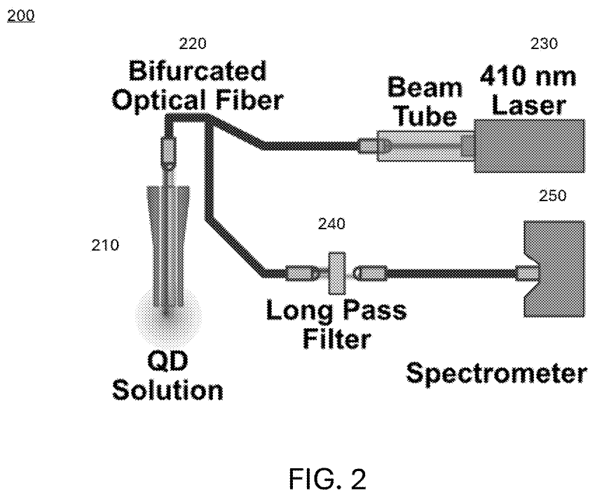

FIG. 2 illustrates an optical probe system 200 adapted for in situ photoluminescence (PL) measurements. The system may employ the same probe architecture described above, with modifications to the optical setup. A laser source 230, such as a diode emitting at a predetermined wavelength, provides excitation light coupled through a bifurcated fiber 220. A long-pass filter 240 is positioned before the spectrometer 250 to block the excitation wavelength and prevent detector saturation, while transmitting the PL emission. The bifurcated fiber 220 includes three legs: a first leg coupled to the laser source, a second leg delivering excitation light to the probe, and a third leg transmitting PL emission to the spectrometer through the long-pass filter.

In an embodiment, the PL configuration leverages the same adjustable mirror 70 and waveguide 60 arrangement as the UV-Vis-IR embodiment, ensuring consistent optical geometry. The ability to vary the path length remains advantageous for PL measurements, as it allows optimization of signal intensity and minimizes reabsorption effects in concentrated solutions. This design enables high-temperature PL monitoring without compromising vacuum integrity or thermal isolation.

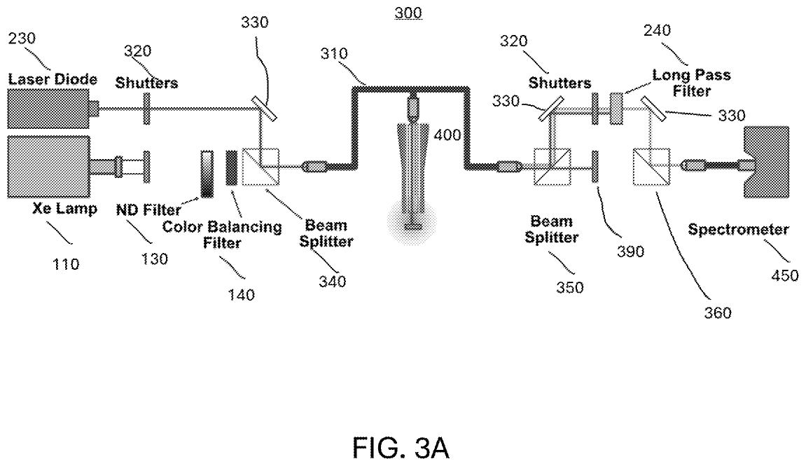

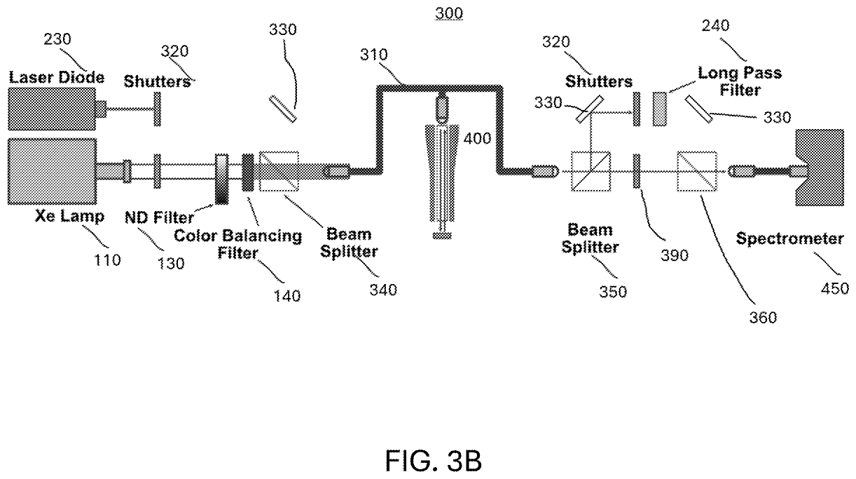

FIGS. 3a and 3b illustrate an optical probe system 300 configured to selectively operate in two distinct modes: a first mode for in situ optical (e.g., UV-Vis-IR) spectroscopy and a second mode for in situ photoluminescence (PL) measurement, The measurements taken in these modes can be carried out at elevated temperature when the probe 400 of FIGS. 1 and 2 is utilized. The system 300 includes a plurality of light sources 110, 230, such as a Xenon lamp 110 for UV-Vis-IR measurements and a laser diode 230 for PL excitation, coupled to a bifurcated optical fiber 310. The bifurcated fiber 310 comprises three legs: a first leg coupled to the light sources 110, 230, a second leg coupled to an in situ UV-Vis-IR/PL probe 400, and a third leg coupled to a spectrometer 450. The probe 400 may be the probe 100, 210 discussed above when references FIGS. 1 and 2. Thus, the probe 400 may include an optical housing 190 containing a collimating lens 10, a main probe body 180 housing a transparent waveguide 60 (e.g., quartz rod), and an adjustable solution window 170 comprising a mirror 70. The mirror 70 reflects light back through the waveguide 60 toward the spectrometer 450, and its position may be adjustable to define the optical path length for quantitative measurements.

FIG. 3a shows the system operating in PL mode. In this configuration, the laser diode 230 is activated, and a first shutter 320 directs excitation light through a first beam splitter 340 toward the probe 400. Emission from the sample is collected by the probe 400 and transmitted through the bifurcated fiber 310 to the spectrometer 450. A long-pass filter 240 may be positioned on the third leg to block the excitation wavelength and prevent detector saturation. Mirrors 330 redirect the optical path between the shutters and beam splitters to maintain alignment while minimizing footprint. The adjustable mirror 70 within the probe 400 ensures optimal signal return and allows fine tuning of the path length for measurements.

FIG. 3b shows the system operating in optical (UV-Vis-IR) mode. In this configuration, the Xenon lamp 110 is selected as the light source, and the shutters 320 are actuated to route broadband light through the first beam splitter 340 and into the probe 400. Light transmitted through the reaction mixture is reflected by the adjustable mirror 70 and returned to the spectrometer 450 via the bifurcated fiber 310. Neutral density filters 130 or spectral balancing filters 140 may be included in the optical path to control intensity and emphasize desired spectral regions. The automated shutter control enables rapid switching between UV-Vis-IR and PL modes without disturbing the probe alignment or the reaction environment.

In certain embodiments, the optical system 300 the beam splitters 340 and multiple mirrors 330 are arranged to provide precise optical routing between the light sources, probe, and spectrometer. The shutters may be motorized and controlled by software to allow automated mode selection during a reaction sequence. The probe assembly remains common to both modes, reducing complexity and ensuring consistent optical geometry. The adjustable solution window 170 and mirror holder 80 allow the path length between the transparent waveguide and the mirror to be varied, which is valuable for both UV-Vis-IR absorbance measurements and PL signal optimization. This dual-mode capability enables comprehensive spectroscopic monitoring under high-temperature and vacuum conditions using a single integrated probe system.

### Examples And Measurements

### Materials

Trioctylphosphine oxide (TOPO) (99%), diphenylphosphine (DPP) (99%), paraffin oil, oleic acid (OA) (technical grade, 90%), 1-octadecene (ODE) (99%), 1-octanethiol (98.5%), stearic acid (95%), cadmium oxide (CdO) (99.99%), and selenium (99.99%) were obtained from Sigma-Aldrich, and were used without further purification. Trioctylphosphine (TOP) (95%) was obtained from Strem, and was used without further purification. n-Octadecylphosphonic acid (ODPA) (98%) was obtained from PCI Synthesis.

Mirrors were fabricated via sequential mechanical polishing from 316 stainless steel blanks produced by electrical discharge machining (EDM) of ingots purchased from McMaster Carr. 316 stainless steel was used for all machined components of the probe. 316 stainless steel is frequently used as the thermocouple sheath material in colloidal nanocrystal synthesis methods. Therefore, 316 stainless steel is inert enough for this use, or at the very least it already has an established predictable effect. Polytetrafluoroethylene (PTFE) 14/20 joint sleeves were obtained.

### Methods

### Synthesis of CdSe QDs for In Situ UV-Vis-IR

For a typical synthesis, CdO (12.9 mg, 0.101 mmol), Stearic Acid (455.2 mg, 1.6 mmol), and TOPO (5 g) were added to a 25 mL flask. Once the probe was aligned (Section 5.3.5.1), it was inserted into the reaction vessel, and the vessel was heated to 100° C. under vacuum for 1 h. After the vessel had been degassed, the temperature controller was set to the desired injection temperature (usually 380° C.). For high injection temperatures, it was necessary to insulate the reaction vessel with aluminum foil in order for the desired temperature to be achievable. At 250° C., TOP (1.8 mL, 4.03 mmol) was injected into the vessel. As the reaction mixture approached the injection temperature, it became increasingly clear, which allowed for fine-tuning of the integration time and data acquisition parameters. The details of the data acquisition are given in section 5.3.5.2. Once the reaction mixture reached injection temperature, TOP-Se (0.2 mL, 0.5M, 0.1 mmol) was swiftly injected, and the reaction was immediately quenched via airjet.

### Synthesis of CdSe/CdS Core/Shell QDs for In Situ PL

Preparation of 0.5M Cd-OA Stock Solution: To a 250 mL flask, CdO (2.57 g, 20 mmol), OA (20 mL), and ODE (20 mL) were added. The solution was degassed for 60 min at 100° C. The flask was then placed under an Ar blanket, heated to 260° C., and kept at 260° C. until all solids were fully dissolved, and the solution color changed to a pale yellow. This solution was cooled to room temperature and kept as a stock solution.

Synthesis of CdSe Cores: To a 50 mL flask, CdO (128.4 mg, 1 mmol), ODPA (0.56 g, 1.7 mmol), and TOPO (6 g) were added. The mixture was degassed at 150° C. under vacuum for 30 min. The flask was then placed under an Ar blanket, and heated to 380° C. At this point, TOP (3 mL) was swiftly injected, and the reaction temperature was allowed to recover to 380° C. Then, TOP-Se (0.75 mL, 2M) partially diluted with DPP (200 μL) was swiftly injected into the flask. The reaction mixture was immediately quenched by airjet to 100° C. The reaction mixture was purified by adding ~1 volume equivalent of toluene to the crude reaction mixture, and adding ethanol until flocculation occurred. The flocculated mixture was centrifuged at 3800 rpm for 5 min. The supernatant was removed, and the pellet was resuspended in hexanes. The flocculation procedure was repeated two more times, using hexanes as solvent and ethanol as anti-solvent. Following the final centrifugation, the QDs were dried under vacuum and redissolved in TOP (4 mL) before being placed in an N2 glovebox.

Synthesis of CdS Shell: The shell growth was carried out after calibrating the desired quantity of precursor. Typically, paraffin oil (6 mL) was degassed at 120° C. for 30 min before adding the CdSe QDs dissolved in TOP from the previous step (0.2 mL). After the CdSe QDs were added, the solution was degassed further for 30 min. The flask was then placed under an Ar blanket, and heated to 240° C. While the flask was heating, Cd-OA (1 mL, 0.5M, prepared using 1:1 volume/volume ratio of OA:ODE) was diluted with ODE (5 mL). Additionally, a solution of octanethiol (84 μL, 0.5 mmol) was diluted in ODE (5 mL). The two solutions were simultaneously injected into the flask at a rate of 5 mLh−1, starting at 240° C. After the first drop hits the surface of the solution, the temperature was raised to 315° C. at a rate of 10° C./min. After the slow injection was completed, OA (2 mL) was swiftly injected into the flask. The reaction mixture was allowed to stir at 315° C. for an additional 30 min before cooling to room temperature.

### Example In Situ UV-Vis-IR Probe

The example optical probe includes 4 components:
1. The optical cage, which houses the collimating lens, fiber optic, and alignment stage
2. A polyether ether ketone (PEEK) heatbreak, which adapts the optical cage to the main probe body, isolates the optical cage from excessive heat, and compresses the Kalrez 4079 o-ring
3. The main probe body, which comprises a threaded upper portion, a 14/20 taper exterior, and the quartz rod
4. The adjustable solution window, which contains a mirror to reflect the incoming light back to the fiber optic

The sealing of the probe to the outside environment was provided by two sealing surfaces. The 14/20 taper cut into the stainless steel portion of the flask was sealed by way of a 14/20 PTFE sleeve with a thin layer of vacuum grease applied to both the inner and outer diameter. The quartz rod was sealed against vacuum and positive pressure by compressing a Kalrez 4079 o-ring against the top of the probe and the quartz rod.

### Instruments

For in situ measurements, a SpectraPhysics 69911 power supply coupled to a SpectraPhysics 66902 with a 300W Xenon arc lamp was used as the light source, and an Ocean Optics Flame (Flame-S-Vis-Nir-ES) was used as the spectrometer. OceanView 2.0.8 software was used for data acquisition. An adjustable gradient neutral density filter wheel was used to adjust the intensity of the light from the xenon lamp, and a Hoya LB165 filter was placed in the optical path to emphasize the intensity of the blue region of the lamp spectrum by attenuating the other regions of the lamp spectrum. For ex situ measurements, UV-Vis-IR spectra were obtained using an Agilent 8453 photodiode array spectrometer. Ex situ photoluminescence measurements were performed on a Horiba Jobin Yvon Fluoromax-3. The schlenk line vacuum was measured using an MKS 925 micropirani gauge.

### Alignment of the In Situ Probe for UV-Vis-IR Spectrum Acquisition

The optical probe was aligned sequentially in the following procedure prior to insertion. First, the internal reflection within the probe was minimized by altering the tilt and translation of the collimating lens while monitoring the intensity of the detected light with the mirror removed. The mirror was then attached to the end of the probe, and the signal intensity was maximized by rotating the mirror assembly. The mirror assembly was then removed, and the lack of internal reflection signal at the detector was once again verified. The mirror assembly was reattached to the end of the probe, and a spacer was used to define the path length while maximizing the signal intensity by rotating the mirror assembly. FIG. 1b can be referred to for a schematic of the setup and final alignment (with exaggerated deviation from the optical axis). The bifurcated optical fiber used for this measurement has a 6+1 arrangement. There is some disagreement among manufacturers as to whether the spectrometer or the light source should have the larger number of fibers (6 in this case). In principle, our light source is intense enough that we are able to run 1 fiber to the light source, and 6 to the spectrometer. In practice, we observed that using 6 fibers for the spectrometer introduced a rotation dependence, whereby rotation of the fiber within the SMA905 connector would cause variations in intensity. This rotation dependence causes significant issues for data analysis, as even small disturbances (such as bumping the fiber prior to injection) can cause unpredictable changes in intensity. We therefore operated the probe with 6 fibers going to the light source and 1 fiber going to the spectrometer.

### Data Acquisition

Once the optical probe was aligned, the integration time was set such that maximum signal was being obtained without the detector being saturated. Prior to injection, the blank and dark references were taken, and the integration time was adjusted to allow for a balance of signal intensity and rapid acquisition. The integration time is adjusted here to ensure spectra can be obtained at later stages of the synthesis where there is a high concentration of QDs. Otherwise, the integration time can be set to achieve the highest temporal resolution of the spectrometer used here. Spectrum averaging was occasionally employed as a post-processing step, in conjunction with a moving average filter. We note that the data acquisition time and the integration time are not the same. At the spectrometer's limit of 1 ms integration time, we are limited to ~10 ms per scan due to the necessary post-integration data processing. Adjusting the integration time between 1 to 3 ms does not increase the acquisition time. This limitation is inherent to the specific spectrometer and its software in our setup. It is not a fundamental limitation. In principle, faster hardware and more optimized software could obtain spectra at a much more rapid cadence. Prior to the injection of precursors, the integration time was adjusted to maximize the signal at the spectrometer without saturation. Typically, the integration time for spectral acquisition was about twice the integration time in air, with 2 to 3 ms integration time being typical. As mentioned previously, adjusting the integration time within the 1 to 3 ms window does not appreciably increase the acquisition time. Therefore, most spectra were obtained with 10 ms per scan time resolution, which is the limit of the commercial spectrometer and software used here. In addition, we note that the spectrometer was operated in relative intensity mode, with nonlinearity correction enabled.

### In Situ Photoluminescence Example

In situ PL was measured using the same probe as described previously, with modifications to the optical setup. The xenon lamp was replaced with a 300 mW laser diode emitting at 410 nm. The intensity at the sample was measured to be 60 mW at the end of the quartz rod using an Edmund Optics LaserCheck. A 450 nm long pass filter was added before the spectrometer, to cut out the excitation wavelength and allow for maximum signal without saturating the spectrometer. Typical integration times were ~6 to 100 ms at room temperature. Spectrum averaging was typically employed for these examples, and the typical acquisition time was 100 ms. We note that the spectrometer used in this example has not been calibrated with a known radiometric standard, and therefore the intensities are relative. However, the agreement with the normalized ex situ example indicates that although the results are not quantitative (in terms of absolute photon counts), the obtained spectra are in good agreement with ex situ spectra. The spectrometer was operated in relative intensity mode, with nonlinearity correction enabled for these example.

### Post-Reaction Cleaning

After a reaction has concluded, the probe is disassembled and cleaned, with particular care being taken to avoid damaging the optics. The o-ring is removed using an o-ring hook, and is washed using a sequence of toluene->acetone->isopropanol. The other components of the probe are washed using the same procedure, except for the stainless steel mirror, which receives the same washing, followed by a rinse with de-ionized water, and a rinse of isopropanol, followed by a jet of nitrogen to facilitate drying

### Ex Situ Measurements

Samples for ex situ measurements were prepared by diluting the crude reaction mixture with 1:1 toluene and adding 60 μL of this solution to a 1 cm path-length quartz cuvette filled with 3 mL toluene. Ex Situ UV-Vis spectra were measured with an integration time of 1 s on an Agilent 8453 photodiode array spectrometer. Ex situ PL spectra were recorded on a Horiba Jobin Yvon Fluoromax-3 spectrofluorometer with an excitation wavelength of 400 nm and an integration time of 1 s.

### Example Results and Discussion

### Challenges Addressed in High-Temperature In Situ UV-Vis-IR Spectroscopy by Exemplary Embodiments

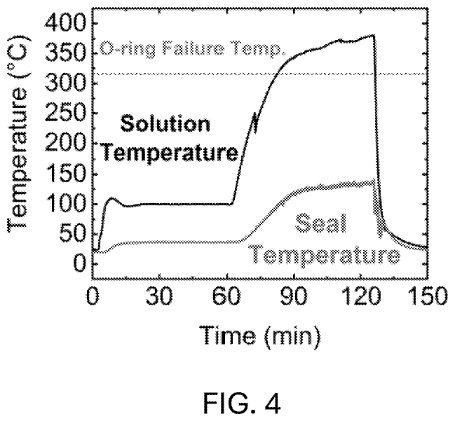

As mentioned previously, the challenges associated with the operation of an in situ optical probe at high reaction temperatures (>300 C) are many. The primary difficulty is obtaining a hermetic seal without using any typical deformable sealing materials in contact with the reaction mixture. A Kalrez 4079 o-ring surrounding a quartz rod which is compressed by the PEEK heatbreak provides the hermetic seal in this example. The location of the o-ring ensures that the temperature experienced by the o-ring is well within the operational limit (~316° C. for Kalrez 4079), while still creating a vacuum and positive pressure seal. The temperature near the o-ring was measured by placing a thermocouple in contact with the stainless steel probe body at the height of the o-ring. The results of this measurement are shown in FIG. 4 and indicate that the o-ring is far enough from the reaction mixture that it remains well within the acceptable operating range. The dotted gray line indicates the failure point of Kalrez o-ring, and the results show that the temperature at the o-ring is much lower than its failure point, even at a reaction temperature of 380° C. The geometry of the seal is similar to feedthroughs for thermocouples and thermometers used in chemical glassware. One purpose of the quartz rod is to define an optical path for the measurements while also providing a means to seal the reaction.

With a robust seal in place, the optics of the probe must be addressed. In order to thermally isolate the fiber optic from the heat and the harsh chemical environment of the reaction mixture, the fiber assembly was located to the top of the optical probe (FIG. 1a). While this guarantees thermal isolation (especially in the presence of the insulating PEEK heatbreak), it complicates the optics necessary to obtain a reliable measurement. The placement of the optical fiber means that it is beneficial to include a collimating lens. In addition, since a custom-length quartz rod was utilized for this example, an anti-reflective coating was not readily available. Minimization of the reflection of the incident light from the first surface of the quartz rod then becomes important. A tilt/translate platform, which allows the collimating lens to be aligned “skew” to the optical axis, was used to minimize this undesirable reflection. While this procedure complicates the alignment of the optical probe, it significantly increases the dynamic range of the probe. The details of the alignment procedure are provided below, and FIG. 1b shows the expected alignment schematically.

As a final point, the light source and path length of the optical probe are important parameters that can significantly affect results. For our examples, we have utilized a high intensity 300W xenon arc lamp with a color balancing filter inserted into the optical path. The color balancing filter emphasizes the “bluer” region of the optical spectrum, while de-emphasizing the “redder” region. This color balancing helps to obtain good UV-Vis spectral data from QDs, which have increasing absorption at energies higher than the band gap. Thus, to obtain spectral detail at photon energy greater than the band gap, higher intensity is necessary, which is contrary to the typical emission profile of most broadband light sources. A gradient neutral density filter is also used to fine-tune the amount of light reaching the spectrometer such that the dynamic range is maximized without saturating the detector. This setup is shown schematically in FIG. 1b. The path length is made adjustable by the use of a set screw which affixes the mirror holder to the main body of the probe. This allows for solutions of many different concentration ranges to be investigated. For CdSe QD synthesis, it is typically necessary to run reactions with a 1 mm gap or less, which constitutes an actual path length of 2 mm. Reducing the gap to <1 mm may hinder solution flow through the gap between the quartz rod and the mirror, even with significant solution agitation via magnetic stirring. Nevertheless auto-diffusion allows for many processes to be observed. For early reaction times where the solution optical density is relatively low, longer path length is not an issue.

### Collecting In Situ UV-Vis Spectra

Prior to collecting UV-Vis spectra, the probe is aligned to minimize the internal reflection off of the quartz rod as detailed above. The probe is then introduced to a standard 3-neck round-bottom-flask by way of the 14/20 joint, which interfaces with the probe body via a teflon sleeve. The solution is heated to degas temperature (typically 100° C.) and is kept there for 1 h under vacuum. The typical measured vacuum on our Schlenk line for a flask with the optical probe is ~4 mTorr, while the typical vacuum for a flask without the optical probe is ~5 mTorr, indicating that the probe provides a similar seal to the “standard” setup.

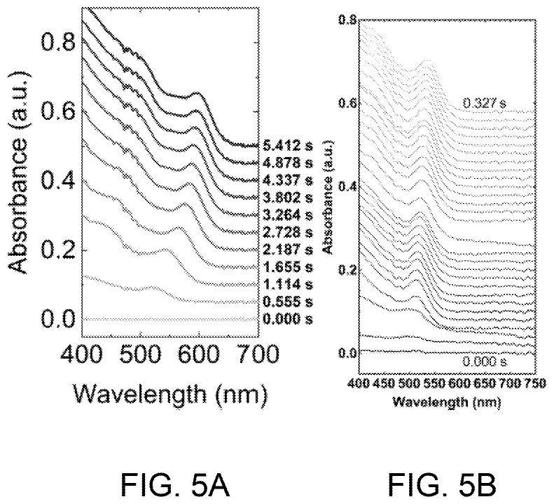

Once the degas cycle is complete, Ar is introduced into the flask, and the solution is heated to the injection temperature, typically between 310 and 380° C. As the reaction mixture is heated, it slowly goes from a turbid suspension to a clear solution. Once the injection temperature has been reached, a blank spectrum and a dark reference are obtained. Prior to the precursor injection, the integration time is adjusted to achieve maximum signal without saturating the spectrometer, typically 1 to 2 ms. The injection is carried out as rapidly as possible, and the quench in temperature is used as a rough timestamp for data analysis. Based on the spectral data obtained with the in situ optical probe presented in FIG. 5a, nucleation and growth/ripening are all accomplished in ~3 to 5 s. Typically, aliquots can be performed at most every ~15 s, if multiple individuals are present, however the error in the time domain for tagging these aliquots is quite large (±3 s). These results demonstrate that the in situ UV-Vis spectra obtained through our optical probe exceeds the time resolution of the aliquot method, while also exceeding the temperature range (100-290° C.) of existing commercial offerings or other in situ methods. We have demonstrated that usable data can be obtained at the fastest acquisition times, as shown in FIG. 5b, where spectra are obtained every ~10 ms. We make a distinction here between acquisition and integration time. The integration time is user-defined and represents the amount of time the CCD array is allowed to accumulate photoexcited charge before being read out. The acquisition time is the integration time plus any post data-processing time, including the time it takes to read the values from the CCD array, send the data to the host computer, apply the nonlinearity correction, and write the result to disk. The acquisition time must necessarily be greater than the integration time, and for a non-real-time operating system (such as Windows 10, utilized for this experiment), the acquisition time will fluctuate somewhat. In our experiments, for integration times of 1 to 3 ms, the acquisition time stayed relatively constant at an average of 10 ms.

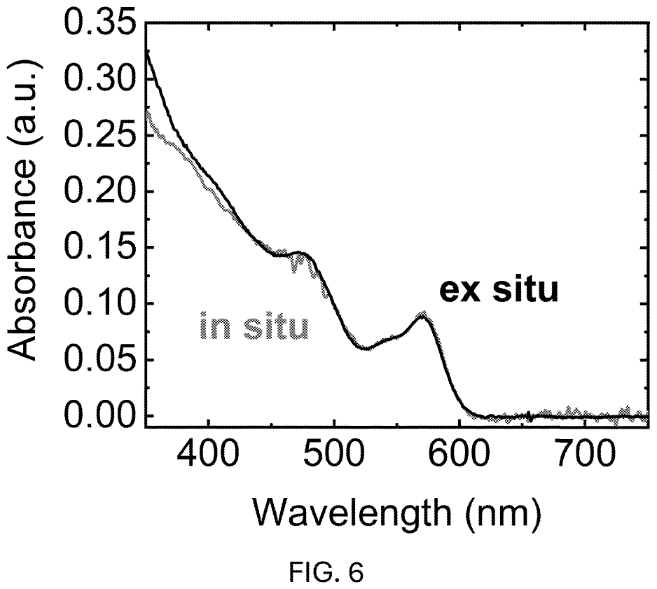

As a control experiment, we have compared the ex situ UV-Vis spectrum of the crude reaction mixture to the in situ spectrum at the end of the reaction (FIG. 6). The in situ spectrum is taken at a temperature slightly above ambient (25.8° C.) in crude solution containing TOPO, stearic acid, and toluene, with an integration time of 2 ms and a physical path length of 1 mm (quartz rod-to-mirror distance of 0.5 mm). By comparison, the ex situ spectrum was taken at ambient temperature (20.2° C.) with an integration time of 1 s and a path length of 1 cm. Note that the sample for ex situ spectrum was prepared by diluting 30 μL of the crude reaction mixture and diluting to 3 mL with toluene. Given the current example setup of our in situ spectrometer (175-875 nm with 2048 pixels), the spectral resolution of our in situ spectrometer is actually somewhat better than our ex situ example setup, however the need to use boxcar smoothing on the resulting spectra reduces the spectral resolution somewhat. We note that the time resolution and spectral detail shown here is not the optimal performance that could be expected from this setup. In particular, we have observed that the primary limitation of our current example setup is the acquisition time of the spectrometer. Even when the integration time is nominally <10 ms, the maximum acquisition rate fluctuates around 10 ms. This is due to software and/or hardware limitations inherent to the commercial spectrometer used here. However, since the optics and light source are external to the reaction mixture, considerably faster time resolution may be possible with a more sophisticated spectrometer (~1 μs per scan).

### Automated Data Analysis and Feature Extraction

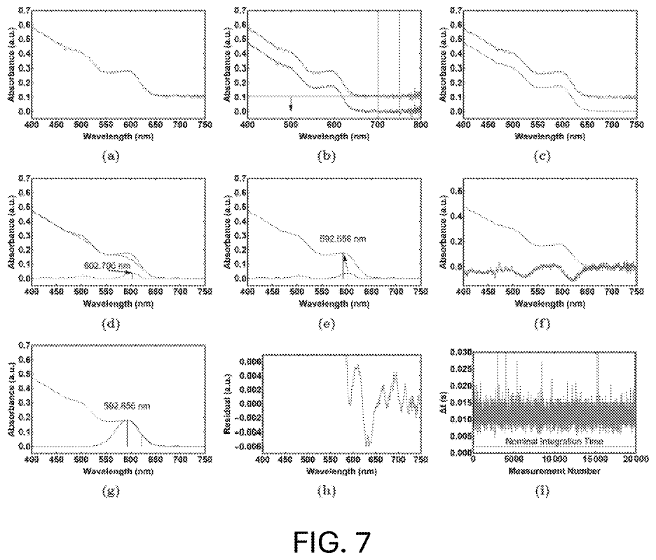

Even with the limitations of the example commercial spectrometer used, a typical in situ reaction can generate upwards of 40,000 spectra, with 2048 data points each. This is a non-trivial amount of data, sometimes exceeding 1 GB for a single reaction. As such, automated analysis is important for obtaining useful information from these spectral series. We have developed an automated data analysis approach that extracts many useful metrics from challenging raw in situ data. The primary steps are presented in FIG. 7.

A challenge of automated processing of QD spectral data is balancing the smoothing necessary for feature extraction with data fidelity. We begin by observing the raw QD spectrum (FIG. 7a), and note that there is a baseline shift, presumably due to fluctuations in the intensity of the light source largely caused by solution stirring. This is corrected by taking the mean value from a section of the spectrum where we do not expect any features, and subtracting this value from the entire spectrum (FIG. 7b). We then apply a 25-point moving average filter (FIG. 7c) to cut down on noise in the spectrum, and improve the results of the background estimation and peak finding (FIG. 7d). Background estimation is used here simply to improve the effectiveness of peak finding algorithms. In this work, we have utilized Mathematica's “EstimatedBackground” function, which relies on Statistically-sensitive Nonlinear Iterative Peak clipping (SNIP). The benefit of this approach is that it requires no human intervention or parameter estimation and can therefore run unattended. Once the background is subtracted, the peak position of the optical gap is estimated. The peak position estimated by this procedure will be red-shifted from the actual value, however it serves as an excellent initial guess. We then refine the peak position (FIG. 7e) by performing a simple windowed search for local maxima on the absorption spectrum. This procedure is certainly not the ideal method for automated peak finding, however processing this amount of data requires balancing accuracy with computational feasibility. We note that it is possible to find these peak positions utilizing the first or second derivative of the spectrum (FIG. 7f shows the first derivative example), however in practice we found this approach required excessive unattended smoothing, was computationally untenable on most high-performance personal computers for extremely large datasets, and was difficult to obtain consistent automated results. For comparison, finding the peak manually by the derivative method results in a peak position of 592.15 nm vs. 592.66 nm obtained through the automated peak-finding shown in FIG. 7e.

With the peak position identified, we can perform a “naive” search for the half-maximum value of the identified peak. This value is then used to define a gaussian (FIG. yg) which provides a quick check as to the effectiveness of the peak find. This relatively simple approach leads to a good fit to the experimental data, as shown in the residual plot (FIG. 7h).

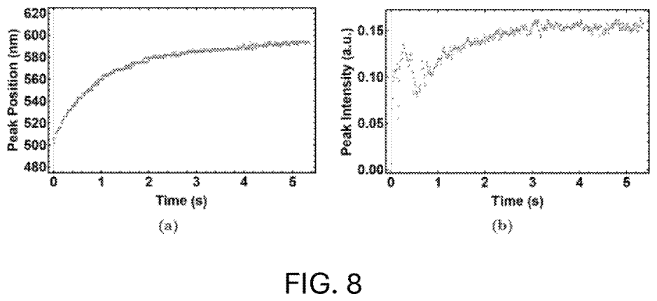

For a typical dataset (36,000 spectra), the procedure outlined in FIG. 7 is able to process all spectra in ~45 min on a personal computer, taking advantage of parallel computing for many steps. This allows us to obtain the peak position as a function of time at very short time scales, as shown in FIG. 8a. This plot shows the expected increase in peak position as a function of time, leveling off to ~590 nm. We are also able to extract the absorbance at the first exciton peak as a function of time (shown in FIG. 5.6b). Rapid absorbance fluctuations near the injection time may be attributed to disturbances in the solution and bubbles brought about by the rapid injection of precursors. We have made considerable headway in reducing this problem, however it may not be possible to entirely eliminate it. First, we have made the bottom surface of the quartz rod the lowest point of the top half of the solution window, meaning that any bubbles will flow up and out of the path length. We have also calibrated our reaction volume such that the top of the solution window is below the surface of the reaction mixture, and we have adjusted the stirring rate so that minimal bubble formation is observed due to solution agitation.

### In Sit Photoluminescence Spectroscopy Example

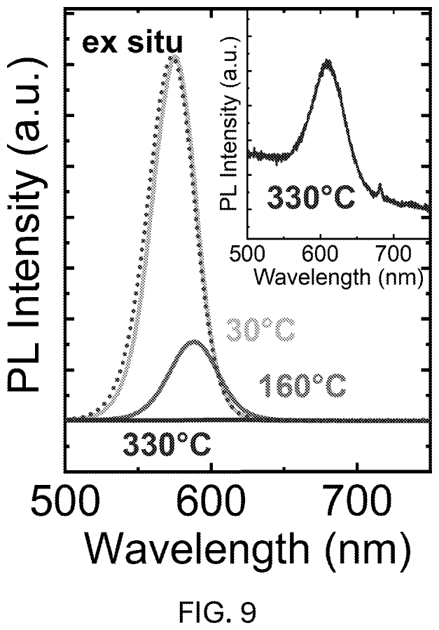

In this example, we performed PL measurements using the optical probe on a solution of CdSe/CdS core/shell QDs at elevated temperatures up to 330° C. (the boiling point of the solvent used), partial results of which are shown in FIG. 9.

Only a slight modification of the optical setup was necessary for in situ PL measurements. In this example, we utilized a 410 nm laser diode, coupled into our bifurcated fiber via a collimating lens, as the excitation source. We also introduced a long pass filter before the spectrometer to cut out the excitation wavelength, allowing for reasonable integration times without spectrometer saturation. Finally, we removed the mirror from the end of the optical probe. As the solution of QDs was heated, the PL quench became quite pronounced, and it was necessary to increase the integration time. This increase in integration time was accounted for in subsequent analysis. The results shown in FIG. 9 demonstrate that high-temperature in situ PL measurements are accomplished with our example optical probe, and that PL from core/shell QDs is measurable even at very elevated temperature (330° C., shown as an inset in FIG. 9).

### Applications

While the examples of our optical probe have focused on monitoring the synthesis of colloidal QDs, the approach can be applied to multiple applications where high-temperature and/or extreme environments are present. Additionally, this probe may allow for measurements of the temperature-dependent optical band-gaps of solution-processable colloidal and molecular semiconductors. As demonstrated, our optical probe is compatible with both in situ UV-Vis-IR and PL measurements at high temperatures. We expect that the upper temperature limit of the probe is at least >400° C., with the primary limitation being the temperature of the probe at the PEEK/316 stainless steel interface. This high-temperature limit gives considerable operational headroom and should even allow for monitoring reactions in extreme reaction conditions, such as in molten salt. In principle, a longer quartz rod/probe would allow for additional temperature headroom, as long as the o-ring is thermally isolated enough to stay under its degradation temperature. Introduction of improved reaction control and automation, coupled with in situ optical measurements enabled by our high-temperature optical probe, may lead to new insights in growth mechanisms, enable precision and repeatability in the synthesis of QDs and QD heterostructures, and accelerate discovery of new QD materials.

### Conclusion

Embodiments of the present disclosure include an in situ optical probe which is capable of high temperature (>300° C.), vacuum tolerant, and inert in most solutions. This probe allows for rapid acquisition (10 ms/scan) of UV-Vis-IR spectra at temperatures previously unexplored and should facilitate additional investigatiIRons into the temperature-dependence of many properties, in addition to measurements of the kinetics of the nucleation and growth of colloidal QDs. PL is also possible using this setup, with modifications to the optics. The setup is capable of rapid acquisition, while also demonstrating parity with ex situ UV-Vis-IR and PL measurements. In addition, in certain embodiments, the probe can interface with commonly available glassware and requires only minimal training to use. Automated data analysis procedures which provide high throughput and result in reasonable fits to the data have also been outlined. A higher performance spectrometer and light source may enable acquisition times as low as 1 μs, with high signal-to-noise ratio, at least for UV-Vis-IR absorption measurements. The low intensities at high temperatures may limit the improvement in time resolution for PL spectroscopy. This probe will enable many investigations that were previously considered intractable, while also facilitating the development of reaction automation.

All of the patents, patent applications, patent application publications and other publications recited herein are hereby incorporated by reference as if set forth in their entirety.

The present invention has been described in connection with what are presently considered to be the most practical and preferred embodiments. However, the invention has been presented by way of illustration and is not intended to be limited to the disclosed embodiments. Accordingly, one of skill in the art will realize that the invention is intended to encompass all modifications and alternative arrangements within the spirit and scope of the invention as set forth in the appended claims.

The invention claimed is:

1. An optical probe system for in situ optical spectroscopy on a high-temperature reaction, comprising:
an in situ optical probe comprising an optical housing, a main probe body, and an adjustable solution window, wherein:
the optical housing is thermally separated from the reaction, the optical housing comprising a collimating lens for receiving and collimating light from a light source;
the main probe body comprises:
a transparent waveguide coupled between the optical housing and the adjustable solution window and transmitting light from the collimating lens to the adjustable solution window;
a sleeve housing and protecting the transparent waveguide, the sleeve being mechanically coupled to the optical housing and the adjustable solution window; and
the adjustable solution window comprises:
a mirror configured to reflect incoming light back to a fiber optic such that in situ optical spectroscopy can be performed on the reflected light, wherein a distance between the mirror and an end of the transparent waveguide is adjustable to modify a path length.

2. The optical probe system of claim 1, further comprising a heatbreak that adapts the optical housing to the main probe body and isolates the optical housing from excessive heat, and a sealing ring surrounding the transparent waveguide and compressed by the heatbreak, wherein the sealing ring provides a hermetic seal under vacuum and positive pressure.

3. The optical probe system of claim 2, wherein the optical housing further comprises a tilt and translate mechanism for adjusting alignment of the collimating lens.

4. The optical probe system of claim 2, further comprising:
a Xenon lamp as the light source,
a color balancing filter receiving light from the light source and accentuating blue light from a spectral signature of the light source;
a bifurcated optical fiber comprising a first leg coupled to the light balancing source by way of a second collimating lens, a second leg coupled into the in situ optical probe by way of the collimating lens of the optical housing, and a third leg; and
a spectrometer coupled to the third leg and measuring spectra of light reflected from the reaction.

5. The optical probe system of claim 1, wherein the transparent waveguide is a quartz rod.

6. The optical probe system of claim 1, wherein the main probe body further comprises a threaded mirror holder for adjusting the distance between the mirror and the end of the transparent waveguide.

7. The optical probe system of claim 1, wherein the mirror comprises polished stainless steel, and the sleeve includes a 14/20 taper for interfacing with chemical glassware.

8. An optical probe system for in situ photoluminescence (PL) measurement of a reaction at elevated temperature, comprising:
a light source;
a bifurcated optical fiber comprising first through third legs, the first leg being coupled to the light source;
an in situ PL probe comprising an optical housing, a main probe body, and an adjustable solution window, wherein:
the optical housing is thermally separated from the reaction, the optical housing comprising a collimating lens for receiving and collimating light from the light source;
the main probe body comprises:
a transparent waveguide coupled between the optical housing and the adjustable solution window and transmitting light from the collimating lens to the adjustable solution window;
a sleeve housing and protecting the transparent waveguide, the sleeve being mechanically coupled to the optical housing and the adjustable solution window; and
the adjustable solution window comprises:
a mirror configured to reflect incoming light back to the bifurcated optical fiber, wherein a distance between the mirror and an end of the transparent waveguide is adjustable to modify a path length,
a spectrometer measuring PL of light reflected by the mirror.

9. The optical probe system of claim 8, wherein the light source is a laser diode.

10. The optical probe system of claim 8, further comprising a long pass filter coupled between the in situ PL probe and the spectrometer on the third leg of the bifurcated optical fiber to cut out excitation wavelength.

11. The optical probe system of claim 8, further comprising a heatbreak that adapts the optical housing to the main probe body and isolates the optical housing from excessive heat, and a sealing ring surrounding the transparent waveguide and compressed by the heatbreak.

12. The optical probe system of claim 8, wherein the main probe body further comprises a threaded mirror holder for adjusting the distance between the mirror and the end of the transparent waveguide.

13. The optical probe system of claim 8, wherein the mirror comprises polished stainless steel, the sleeve includes a 14/20 taper for interfacing with chemical glassware, and the transparent waveguide is quartz.

14. An optical probe system for switching between in situ optical spectroscopy and in situ photoluminescence (PL) measurement of a reaction at elevated temperature, the optical probe system comprising:
a plurality of light sources;
a bifurcated optical fiber comprising first through third legs, the first leg being coupled to the plurality of light sources;
an in situ probe comprising an optical housing, a main probe body, and a mirror, wherein:
the optical housing is thermally separated from the reaction and receives light from one of the plurality of light sources;
the main probe body comprises:
a transparent waveguide coupled between the optical housing and the mirror and transmitting light to the mirror;
wherein the in situ probe is coupled to the plurality of light sources by way of the second arm of the bifurcated optical fiber such that the in situ optical PL probe can be selectively operated in a first mode in which in situ optical spectroscopy is performed for measurements across ultraviolet (UV), visible (Vis) and infrared (IR) spectra and a second mode in which in situ photoluminescence (PL) measurement is performed; and
wherein the third leg couples to a spectrometer for measuring spectra and PL depending upon which of the first and second modes is selected.

15. The optical probe system of claim 14, further comprising one or more shutters for switching between the first and second modes.

16. The optical probe system of claim 15, further comprising first and second beam splitters, and wherein:
the one or more shutters comprises a first shutter and a second shutter, the first shutter being coupled between one of the plurality of light sources and the first beam splitter, the first beam splitter being coupled between the first shutter and the in situ optical PL probe, the second beam splitter being coupled between the in situ optical PL probe and the second shutter, and the second shutter being coupled between the second beam splitter and the spectrometer.

17. The optical probe system of claim 16, further comprising a plurality of mirrors for redirecting light between the first and second shutters and the first and second beam splitters.

18. The optical probe system of claim 14, wherein the in situ optical PL probe further comprises a collimating lens housed in the optical housing, a heatbreak that adapts the optical housing to the main probe body and isolates the optical housing from excessive heat, a sealing ring surrounding the transparent waveguide and compressed by the heatbreak, and a sleeve housing and protecting the transparent waveguide.

19. The optical probe system of claim 14, wherein a path length between the transparent waveguide and the mirror is configured to be adjustable.

20. The optical probe system of claim 14, wherein the plurality of light sources include a Xe lamp and a laser diode.
